(19) United States
(12) Patent Application Publication
(10) Pub. No.: US 2017/0218987 A1
(43) Pub. Date: Aug. 3, 2017

(54) SCREW BOSS LOCATORS AND TORQUE RESISTORS

(71) Applicant: THOMSON LICENSING, Issy les Moulineaux (FR)

(72) Inventors: Christopher Michael William PROCTOR, Westfield, IN (US); Joseph Lee CARPENTER, Noblesville, IN (US)

(21) Appl. No.: 15/039,256

(22) PCT Filed: Nov. 6, 2014
(86) PCT No.: PCT/US2014/064270

§ 371 Date: May 25, 2016

Related U.S. Application Data
(60) Provisional application No. 61/908,783, filed on Nov. 26, 2013.

(51) Int. Cl. F16B 5/02; F16B 19/02

(52) U.S. Cl. CPC F16B 5/025; F16B 19/02

(57) ABSTRACT

The present principles of the embodiments generally relate to an apparatus and a method for bosses such as, for example, screw bosses, serving for multiple purposes. In one exemplary embodiment, a boss comprising a plurality of ribs is mated with a guide comprising a plurality of slots to resist twisting motion of the screw boss when a screw is inserted into the screw boss.

### RELATED APPLICATION

This patent application claims the benefit of U.S. Provisional Application No. 61/908783 on Nov. 26, 2013 and titled “Screw Boss Locators and Torque Resistors.”

### BACKGROUND OF THE INVENTION

Field of the Invention

The present principles of the embodiments generally relate to an apparatus and a method for bosses such as, for example, screw bosses, serving for multiple purposes. In one exemplary embodiment, a boss comprising a plurality of ribs is mated with a guide comprising a plurality of slots to resist twisting motion of the screw boss when a screw is inserted into the screw boss.

Background Information

The invention concerns bosses such as, for example, screw bosses, serving for multiple purposes.

As well known in the art, a boss is used e.g., when there is a need for a mounting point, a location point, a reinforcement around a hole, or a space, especially in plastic molding applications such as a plastic casing for an electronic apparatus. A boss may receive a screw, an insert, or a plain shaft (either as a slide or a press fit).

It is important in a design to locate parts based off the other parts in the assembly. If parts are not located correctly, problems may result. Interference, part misalignment, and gaps are just a couple of the issues that could occur.

### SUMMARY OF THE INVENTION

The present inventors recognize the need to improve the existing apparatus and methods for providing bosses such as, for example, screw bosses to serve multiple purposes.

In accordance with an aspect of the present invention, an apparatus is presented, comprising:

at least one boss extruding from a surface of the apparatus, wherein the boss further comprising a plurality of ribs; and

a guide for mating with the boss wherein the guide comprises a plurality of slots for mating with the plurality of ribs of the boss.

In another exemplary embodiment, a screw boss is presented comprising:

a circular center; and

a plurality of ribs extending from the circular center; and wherein

the plurality of ribs are capable of mating with a guide comprising a plurality of slots to resist twisting motion of the screw boss when a screw is inserted into the screw boss.

In another exemplary embodiment, a method for assembling an apparatus is presented comprising:

using at least one boss extruding from a surface of the apparatus, wherein the boss further comprising a plurality of ribs; and

mating a guide with the boss wherein the guide comprises a plurality of slots for mating with the plurality of ribs of the boss.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

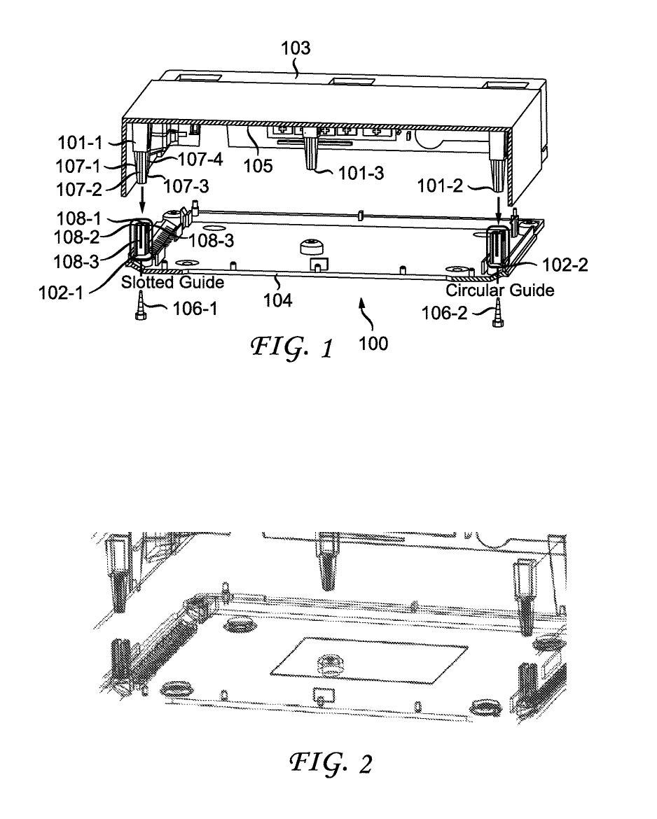

FIGS. 1 and 2 show the slotted and circular guides in order to locate the top casing;

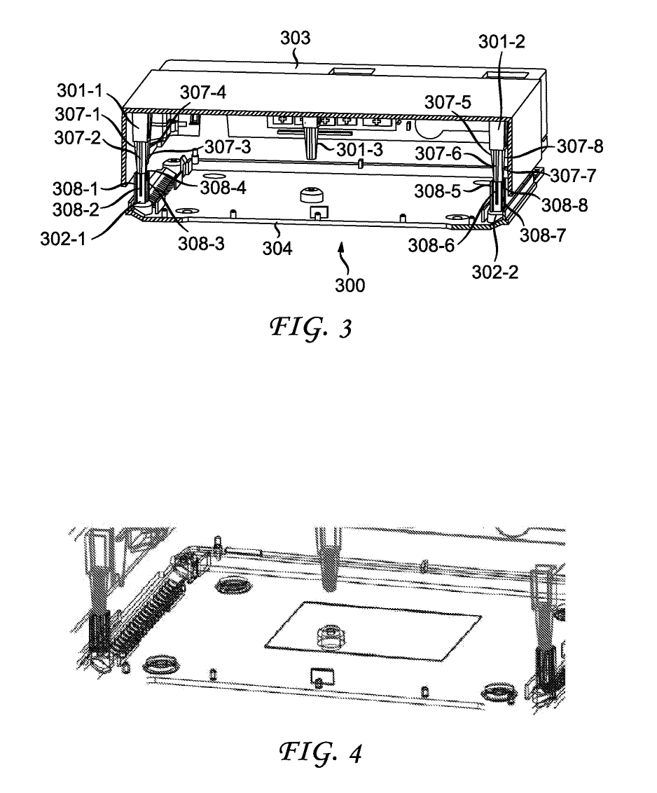

FIGS. 3 and 4 show the long screw bosses that allow the top casing to engage the guides 17 mm from its seated position; and

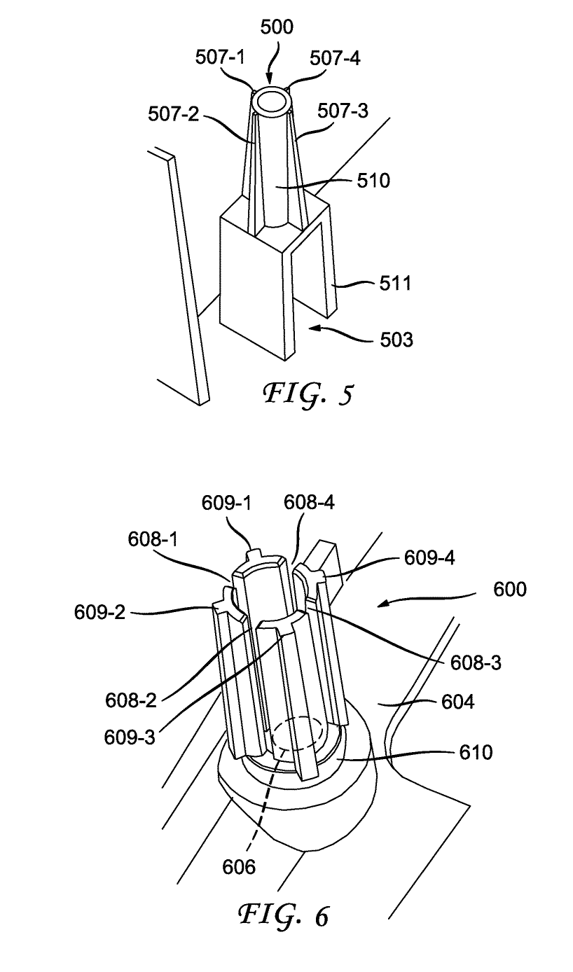

FIGS. 5 and 6 show that once seated, the parts can be screwed together while the ribs are reinforced by the features on the bottom casing.

The examples set out herein illustrate exemplary embodiments of the invention. Such examples are not to be construed as limiting the scope of the invention in any manner.

### DETAILED DESCRIPTION

The invention concerns bosses, e.g., screw bosses, serving for multiple purposes. It is important in a design to locate parts based off the other parts in the assembly. If parts are not located correctly, problems may result. Interference, part misalignment, and gaps are just a couple of the issues that could occur.

As shown in FIG. 1, to prevent these problems and reduce risk, we decided to guide and locate the top casing 103 via the long screw bosses (e.g., 101-1 and 101-2) extruding from the inside surface 105. By using these long features to locate, we are also guiding the top casing 103 into place well before the piece is seated on the bottom casing 104.

While these features work great for locating and guiding, they might exhibit some weakness when driving a screw (e.g., 106-1 or 106-2) into them. To solve such a potential problem, we decided to add ribs (e.g., 107-1, 107-2, 107-3 and 107-4) in four locations on the screw bosses 101-1 and 101-2. The mating feature (e.g., slots 108-1, 108-2, 108-3 and 108-4) in the bottom casing 104 would capture these ribs (e.g., 107-1, 107-2, 107-3 and 107-4), thus resisting the shearing or twisting motion of the screw bosses 101-1 and 101-2 as the torque is applied to the screws 106-1 and 106-2. By reinforcing these bosses 101-1 and 101-2, there is a smaller chance of breakage during assembly, drop test, vibration, etc.

FIG. 2 shows transparent views of the respective parts of the casing 100 shown in FIG. 1.

As shown in FIG. 3, not only are the multipurpose screw bosses (e.g., 301-1 and 301-2) used for attachment, but they locate as well as guide. The mating features (e.g., slots 308-1 to 308-4 and 308-5 to 308-8 of guides 302-1 and 302-2 respectively) in the bottom cover 304 then reinforce the screw bosses 301-1 and 301-2 by capturing the ribs (307-1 to 307-4, and 307-5 to 307-8 respectively) on them to prevent rotation. One of the inventive features disclosed herein includes guiding (due to the length of the screw boss) and reinforcing the resistance of the screw boss to the torque applied during assembly.

FIG. 4 shows transparent views of the respective parts of the casing 300 shown in FIG. 3.

FIG. 5 shows an exemplary boss 500 according to principles of the present invention. As shown in FIG. 5, a screw boss 500 has four exemplary ribs 507-1 to 507-4 extending from a hollowed center body 510. The center body 510 and the ribs 507-1 to 507-4 are formed on top of a base 511. Exemplary guide 500 extrudes from a surface 503 which is e.g., an inside surface 105 of top part 103 of casing 100 shown in FIG. 1.

As can be seen from FIG. 5, the ribs 507-1 to 507-4 of the boss 500 are tapered toward the mating end of boss 500 so that the boss has a smaller diameter at the mating end. In addition, the total length of the boss 500 is substantially the same as the height of the casing 100 shown in FIG. 1. These features allow the boss to be easily guided and mated to a guide 600 (to be described in connection with FIG. 6 below) and provide reinforcement to the casing 100 in FIG. 1.

FIG. 6 shows an exemplary guide 600 for mating with, e.g., the exemplary boss 500 shown in FIG. 5, according to principles of the present invention. As shown in

FIG. 6, exemplary guide 600 comprises four slots 608-1 to 608-4. The slots 608-1 to 608-4 are for mating with the exemplary ribs 507-1 to 507-4 shown in FIG. 5. Slots 608-1 to 608-4 are formed by four exemplary structures 609-1 to 609-4. The four structures 609-1 to 609-4 rest on a hollow guide base 610 which extrudes from a surface 604 which is e.g., an inside surface of the bottom part 104 of casing 100 as shown in FIG. 1. A screw (e.g., 106-1 of FIG. 1) may be inserted through a hole 606 of the hollow body 610 of FIG. 6 from the outside surface of the bottom part 104 of casing 100 of FIG. 1. It can be seen from FIGS. 5 and 6 that the length of ribs 507-1 to 507-4 shown in FIG. 5 is substantially the same as slots 608-1 to 608-4 shown in FIG. 6.

This invention can be used between any two parts in an enclosure. The capturing of the ribs on the screw bosses is another inventive feature disclosed herein. The advantages include using one feature for multiple purposes (attaching, aligning, guiding) and minimizing risk of breakage.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and to configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments.

1. An apparatus comprising:
at least one boss extruding from a surface of the apparatus, wherein the boss comprising a plurality of ribs; and
a guide for mating with the boss wherein the guide comprising a plurality of slots for mating with the plurality of ribs of the boss.

2. The apparatus of claim 1 wherein the boss is a screw for insertion of a screw.

3. The apparatus of claim 2 wherein the plurality of slots of the guide reinforce resistance of the screw boss to torque applied to the screw.

4. The apparatus of claim 2 wherein a number of the plurality of ribs is four.

5. The apparatus of claim 4 wherein a number of the plurality of slots is four.

6. The apparatus of claim 5 wherein the apparatus is a casing having a first part and a second part, the surface is an inside surface of the first part, the guide is on the second part of the casing and the screw is inserted through the second part.

7. The apparatus of claim 6 wherein length of the boss enables the boss to be aligned and guided into the guide when the first part of the casing is being mated to the second part of the casing.

8. The apparatus of claim 3 wherein the boss is circular and the plurality of ribs extend radially from the boss.

9. The apparatus of claim 8 wherein a length of the ribs is smaller than a length of the boss.

10. The apparatus of claim 8 wherein the boss is tapered toward an end of the boss.

11. The apparatus of claim 8 wherein the plurality of ribs are tapered toward an end of the boss.

12. The apparatus of claim 11 wherein the length of the boss is substantially the same as a height of the casing.

13. An method for assembling an apparatus comprising:
using at least one boss extruding from a surface of the apparatus, wherein the boss comprising a plurality of ribs; and
mating a guide with the boss wherein the guide comprising a plurality of slots for mating with the plurality of ribs of the boss.

14. The method of claim 13, wherein the boss is a screw boss and the method further comprising a step of inserting a screw through the guide and into the boss.

15. The method of claim 14 wherein the plurality of slots of the guide reinforce resistance of the screw boss to torque applied to the screw.

16. The method of claim 14 wherein a number of the plurality of ribs is four.

17. The method of claim 16 wherein a number of the plurality of slots is four.

18. The method of claim 17 wherein the apparatus is a casing having a first part and a second part, the surface is an inside surface of the first part, the guide is on the second part of the casing and the screw is inserted through the second part.

19. The method of claim 18 wherein length of the boss enables the boss to be aligned and guided into the guide when the first part of the casing is being mated to the second part of the casing.

20. The method of claim 15 wherein the boss is circular and the plurality of ribs extend radially from the boss.

21. The method of claim 20 wherein a length of the ribs is smaller than a length of the boss.

22. The method of claim 20 wherein the boss is tapered toward an end of the boss.

23. The method of claim 20 wherein the ribs are tapered toward the end of the boss.

24. The method of claim 23 wherein the length of the boss is substantially the same as a height of the casing.
